(19) United States
(12) Patent Application Publication
(10) Pub. No.: US 2020/0120388 A1
(43) Pub. Date: Apr. 16, 2020

(54) APPARATUS AND METHOD OF PREVENTING CHILDREN FROM CLOSE-UP SCREEN VIEWING, AND RECORDING MEDIUM STORING PROGRAM THEREFOR

(71) Applicant: Yeong Wan YUN, Gangwon-do (KR)

(72) Inventor: Yeong Wan YUN, Gangwon-do (KR)

(21) Appl. No.: 16/191,925

(22) Filed: Nov. 15, 2018

(30) Foreign Application Priority Data
Oct. 15, 2018 (KR) 10-2018-0122608

(51) Int. Cl. H04N 21/454; H04N 21/472; G01S 15/08; H04N 21/485; H04N 21/442

(52) U.S. Cl. CPC H04N 21/4542; H04N 21/47214; H04N 21/44204; H04N 21/4852; G01S 15/08

(57) ABSTRACT

In an apparatus for preventing children from close-up screen viewing, a viewing distance determining unit determining whether or not a viewing distance of a user is equal to or smaller than a reference distance; and a viewing blocking unit performing at least one of blocking output to a screen and switching the screen to silent when the viewing distance is equal to or smaller than the reference distance are provided.

### CROSS REFERENCE TO RELATED APPLICATION

The present application claims priority to Korean Patent Application No. 10-2018-0122608, filed Oct. 15, 2018, the entire contents of which is incorporated herein for all purposes by this reference.

### BACKGROUND OF THE INVENTION

### Field of the Invention

The present invention relates generally to a technique of improving viewing habits of children.

### Description of the Related Art

Smartphones have become an essential belonging for modern people. In addition to providing phone calls and text messaging, smartphones have become an essential instrument for enjoying leisure activities such as web surfing, playing games, watching movies, browsing and creating documents, etc. and for performing business work. In addition, for children, parents' smartphones are being used as viewing tools to enjoy children's videos through YouTube.

Meanwhile, a proper distance is required to be maintained when viewing videos, and thus attention and guidance of parents are required when children watch videos. However, it is difficult for parents, especially when both parents work, to constantly monitor children's viewing habits. Therefore, a method of improving viewing habits of children is required.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korea Patent No. 10-1616158 (Published on Apr. 27, 2016)

### SUMMARY OF THE INVENTION

An object of the present invention is to provide a technique of improving viewing habits of children.

According to an aspect, the present invention provides an apparatus for preventing children from close-up screen viewing, the apparatus including: a viewing distance determining unit determining whether or not a viewing distance of a user is equal to or smaller than a reference distance; and a viewing blocking unit performing at least one of blocking output to a screen and switching the screen to silent when the viewing distance is equal to or smaller than the reference distance.

The apparatus may further include a target determining unit determining whether or not the user is a target for preventing from close-up screen viewing, wherein the viewing blocking unit may function when the user is the target for preventing from close-up screen viewing.

The target determining unit may determine that the user is the target to be prevented from close-up screen viewing when a screen touch range of the user is equal to or smaller than a reference range.

The apparatus may further include a volume limiting unit variably setting a maximum volume according to a neighbor noise decibel.

The apparatus may further include a virtual call forwarding unit displaying a virtual call forward screen when a viewing time of the user reaches a predetermined time.

The apparatus may further include a remote control transmitter transmitting to a digital broadcast receiver a command for performing at least one of blocking output to the screen or switching the screen to silent when a distance with the digital broadcast receiver is equal to or smaller than a predetermined distance.

According to another aspect, the present invention provides a method of preventing children from close-up screen viewing, the method including: determining whether or not a viewing distance of a user is equal to or smaller than a reference distance; and performing at least one of blocking output to a screen and switching the screen to silent when the viewing distance is equal to or smaller than the reference distance.

The method may further include determining whether or not the user is a target for preventing from close-up screen viewing, wherein the performing of at least one of blocking output to the screen and switching the screen to silent may be performed when the user is determined as the target for preventing from close-up screen viewing.

The user may be determined as the target to be prevented from close-up screen viewing when a screen touch range of the user is equal to or smaller than a reference range.

The method may further include variably setting a maximum volume according to a neighbor noise decibel.

The method may further include displaying a virtual call forward screen when a viewing time of the user reaches a predetermined time.

The method may further include transmitting a command for performing at least one of blocking output to the screen or switching the screen to silent when a distance with the digital broadcast receiver is equal to or smaller than a predetermined distance.

According to another aspect, the present invention provides a computer readable recording medium storing a program for a method of preventing children from close-up screen viewing, wherein the method includes: determining whether or not a viewing distance of a user is equal to or smaller than a reference distance; and performing at least one of blocking output to a screen and switching the screen to silent when the viewing distance is equal to or smaller than the reference distance.

According to the disclosure, when a child wants to watch content closely, output of a screen is blocked or switched to silent so that the child is prevented from viewing the content unless a proper distance is maintained. In addition, when a child watches content for a long time, a phone call forward screen is displayed so that the child feels as though a phone call has been received. Therefore, children are prevented from viewing a screen for a long time.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view of a block diagram of an apparatus for preventing children from close-up screen viewing according to an embodiment of the present invention;

FIG. 2 is a view of a flowchart of a method of preventing children from close-up screen viewing according to an embodiment of the present invention; and

FIG. 3 is a view of a flowchart of a method of preventing children from close-up screen viewing according to another embodiment of the present invention.

### DETAILED DESCRIPTION OF THE INVENTION

The above-mentioned and additional aspects of the present invention may be clearer through preferred embodiments, which are described with reference to attached figures. Hereinafter, the present invention is specifically described so as to help those skilled in the art easily understand and implement the present invention through these exemplary embodiments.

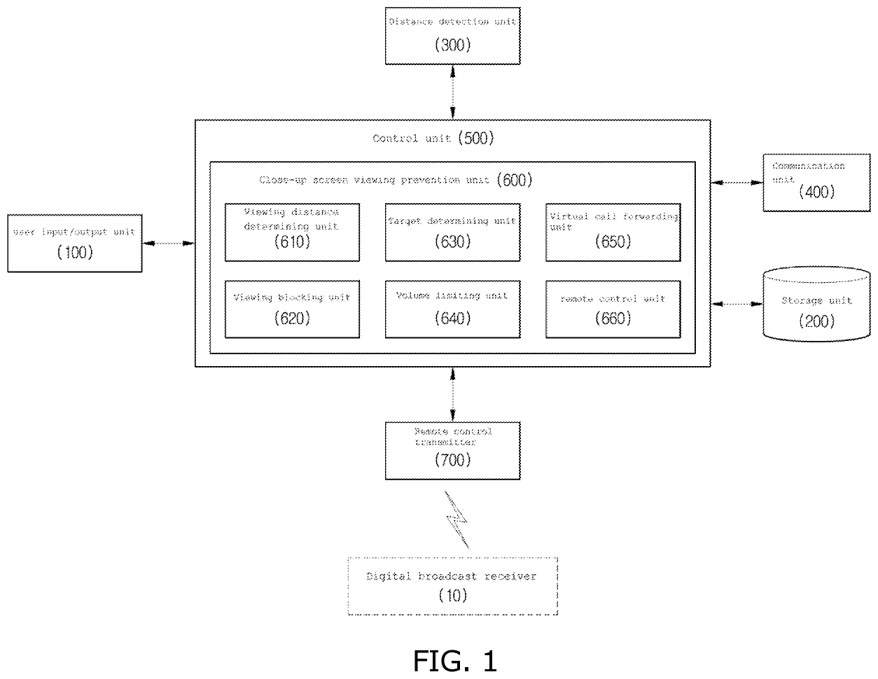

FIG. 1 is a view of a block diagram of an apparatus for preventing children from close-up screen viewing according to an embodiment of the present invention. An apparatus for preventing children from close-up screen viewing is a display device. In an embodiment, the apparatus for preventing children from close-up screen viewing is a mobile terminal such as a smartphone. A user input/output unit 100 provides a user input interface and a user output interface. As a user input interface, a touch screen and a microphone may be used, and as a user output interface, display devices such as OLED (organic light emitting diodes), TFT-LCD (thin film transistor-liquid crystal display), etc. and a speaker may be used. In addition, a touch panel and a display device may be provided in a touch screen form by being integrated. A storage unit 200 is a medium for storing instructions, data, and programs, and may be configured by including at least one memory. In such a storage unit 200, a program for preventing children from close-up screen viewing may be stored.

A communication unit 400 includes at least one transceiver for communication with the outside. The communication unit 400 supports at least one communication protocol, for example, TCP/IP, IPX, SPX, NetBIOS, Ethernet, ARCNET, fiber distributed date interface (FDDI), IEEE 802.11, IEEE 802.11a, etc., and supports at least one of a communication protocol such as direct synchronization attach. A distance detection unit 300 is a sensor for detecting a distance, and may be an ultrasonic sensor. The distance detection unit 300 is used for detecting a distance between a user and an apparatus for preventing children from close-up screen viewing. A control unit 500 may be configured by including hardware with at least one processor and an operating system. A control unit 500 according to an aspect includes a close-up screen viewing prevention unit 600. In an embodiment, the close-up screen viewing prevention unit 600 is a program for preventing children from close-up screen viewing which is stored in the storage unit 200, and is executed by being loaded by the control unit 500. The close-up screen viewing prevention unit 600 may be an application, and may be stored in the storage unit 200 by being downloaded from an app. store.

The close-up screen viewing prevention unit 600 may include a viewing distance determining unit 610 and a viewing blocking unit 620, and may further include at least one of a target determining unit 630, a volume limiting unit 640, a virtual call forwarding unit 650, and a remote control unit 660. The above units are a software functional module, and each of the same performs a preset function. The viewing distance determining unit 610 determines whether or not a viewing distance of a user is equal to or smaller than a reference distance. In an embodiment, the viewing distance determining unit 610 activates the distance detection unit 300, and determines whether or not a distance between a user and the apparatus for preventing children from close-up screen viewing, which is a viewing distance detected by the distance detection unit 300, is equal to or smaller than a reference distance. In addition, the viewing blocking unit 620 blocks output of a display screen or switch the display screen to silent so as to prevent video sound when the viewing distance is determined to be equal to or smaller than the reference distance. Of course, the viewing blocking unit 620 may perform both of blocking output of the display screen and switching the display screen to silent (mute processing).

The target determining unit 630 determines whether or not a user is a target to be prevented from close-up screen viewing. In an embodiment, the target determining unit 630 recognizes a fingerprint of the user, and when the recognized fingerprint is registered as a target to be prevented from close-up screen viewing, the target determining unit 630 determines that the user is a target to be prevented from close-up screen viewing. In another embodiment, the target determining unit 630 may recognize a facial image of a user by using a camera provided in the apparatus for preventing children from close-up screen viewing, and when the recognized facial image is registered as a face to be prevented from close-up screen viewing, the target determining unit 630 determines that the user is a target to be prevented from close-up screen viewing. In another embodiment, when a range of user one-touch on a screen is equal to or smaller than a reference range, the target determining unit 630 determines that the user is a target to be prevented from close-up screen viewing. As a child's fingers are small compared to adult fingers and a reference range is set properly, the child may be prevented from close-up screen viewing when the child tries to watch a video.

In an embodiment, when the target determining unit 630 is included in the close-up screen viewing prevention unit 600, the viewing blocking unit 620 performs at least one of blocking output to a screen and switching the screen to silent when a user is a target to be prevented from close-up screen viewing. Herein, the viewing distance determining unit 610 may perform or may not perform a corresponding function. In another embodiment, when the target determining unit 630 is included in the close-up screen viewing prevention unit 600, the viewing distance determining unit 610 performs a corresponding function when the user is a target to be prevented from close-up screen viewing.

The volume limiting unit 640 variably sets a maximum volume value according to a decibel of a sound input through a microphone. In other words, a maximum volume is set differently depending on ambient noise. In an embodiment, the volume limiting unit 640 sets a maximum volume to be lower than a decibel of a sound input through a microphone. This is to prevent people from being exposed to noise caused when a child views a video in a public place.

The virtual call forwarding unit 650 displays a virtual call forward screen when a viewing time of a user reaches a predetermined time. Herein, the user may be a user determined as a target to be prevented from close-up screen viewing by the target determining unit 630. In an embodiment, the virtual call forwarding unit 650 displays a virtual call forward screen when a continuous viewing time of the user reaches a first time. The first time may be 20 minutes, and may be variably set by parents. In an additional embodiment, the virtual call forwarding unit 650 displays a virtual call forward screen when a daily viewing time of the user reaches a second time. The second time may be an hour, and may be variably set by parents.

The remote control unit 660 transmits to a digital broadcast receiver 10 a command of at least one of blocking output to a screen and switching the screen to silent when a distance with the digital broadcast receiver 10 is equal to or smaller than a predetermined distance. Herein, the digital broadcast receiver 10 may be a TV, or a set-top box connected to a TV. In an embodiment, the remote control unit 660 activates the distance detection unit 300, and determines whether or not a distance between a TV and the apparatus for preventing children from close-up screen viewing, which is a viewing distance detected by the distance detection unit 300, is equal to or smaller than a predetermined distance. When the distance is equal to or smaller than a predetermined distance, the remote control unit 660 controls to transmit a command signal of at least one of blocking output to a screen and switching the screen to silent to the digital broadcast receiver 10. In order to transmit a command signal, the apparatus for preventing children from close-up screen viewing may further include a remote control transmitter 700. The remote control transmitter 700 may be an ultrasonic transmitter, and transmits to the digital broadcast receiver 10 a signal including a corresponding command according to a control of the remote control unit 660.

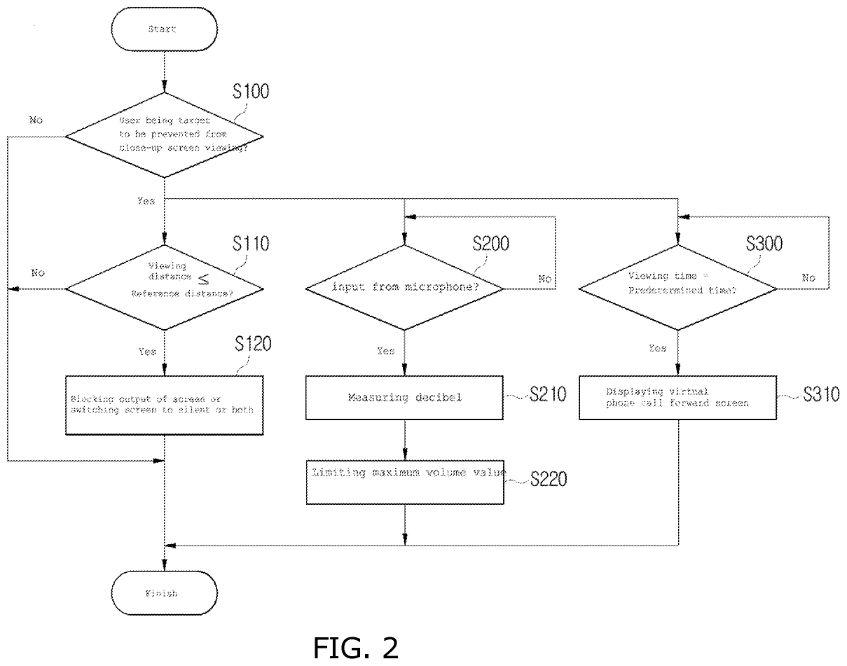

FIG. 2 is a view of a flowchart of a method of preventing children from close-up screen viewing according to an embodiment. In S100, a processor determines whether or not a user is a target to be prevented from close-up screen viewing. As described above, the processor may determine whether or not the user is a target to be prevented from close-up screen viewing by recognizing a user fingerprint or by a touch range of the user. When the user is determined to be a target to be prevented from close-up screen viewing in S100, in S110, the processor determines whether or not a viewing distance of the user, which is detected by the distance detection unit 300, is equal to or smaller than a reference distance. When the viewing distance is determined to be is equal to or smaller than a reference distance in S110, in S120, the processor may block output of a display screen or switch the display screen to silent (mute processing) or both.

Meanwhile, when the user is determined to be a target to be prevented from close-up screen viewing in S100, in S200 and S210, when a voice is input through the microphone, a decibel of the input sound is measured. Herein, the processor may activate the microphone when the user is determined to be a target to be prevented from close-up screen viewing in S100. In S220, the processor limits, that is, variably sets a maximum volume according to the measured decibel. Herein, the limited maximum volume may be applied only to a video that is currently playing.

Meanwhile, when the user is determined to be a target to be prevented from close-up screen viewing in S100, in S300, the processor determines whether or not a viewing time of the user reaches a predetermined time. When the viewing time of the user is determined to reach a predetermine time in S300, in S310, the processor displays a virtual call forward screen. As described above, the processor may display a virtual call forward screen when a continuous viewing time of the user reaches a first time, and display a virtual call forward screen when a daily viewing time of the user reaches a second time. In addition, S100 of FIG. 2 described above may be omitted. Herein, S110, S200, and S300 may be performed regardless of whether or not a user is a target to be prevented from close-up screen viewing.

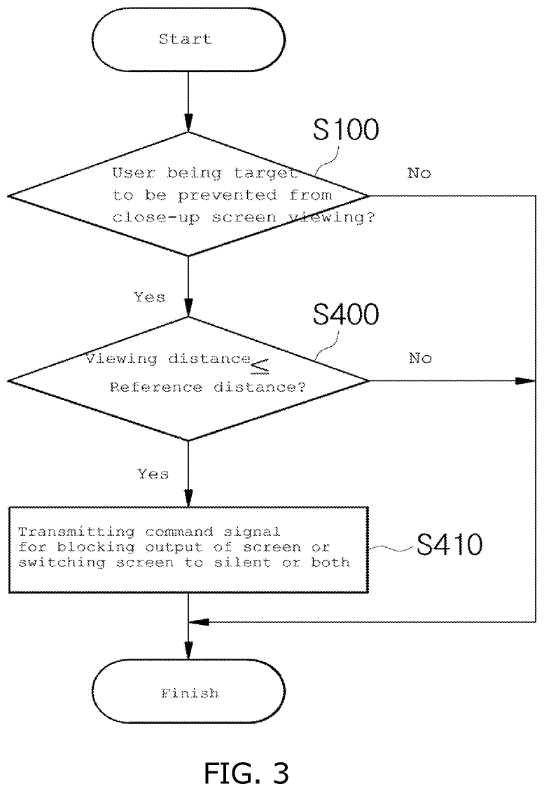

FIG. 3 is a view of a flowchart of a method of preventing children from close-up screen viewing according to another embodiment. In S100, the processor determines whether or not a user is a target to be prevented from close-up screen viewing. As described above, the processor may determine whether or not the user is a target to be prevented from close-up screen viewing by recognizing a user fingerprint or by a touch range of the user. When the user is determined to be a target to be prevented from close-up screen viewing in S100, in S400, the processor determines whether or not a viewing distance of the user which is detected by the distance detection unit 300 is equal to or smaller than a predetermined distance. Herein, the viewing distance means a distance between the digital broadcast receiver 10 and the apparatus for preventing children from close-up screen viewing. When the viewing distance is determined to be equal to or smaller than the reference distance in S400, in S410, the processor controls to transmit a command signal for blocking output of the display screen or mute processing or both by using the remote control transmitter 700. Accordingly, the digital broadcast receiver 10 receives the command signal and performs blocking output of the display screen or mute processing or both.

Meanwhile, the method of preventing children from close-up screen viewing may be implemented through computer programs. Codes and code segments configuring each of the computer programs can be easily derived by a skilled computer programmer in this art. In addition, the above program may be stored in a computer readable recording medium, and a method of preventing children from close-up screen viewing may be implemented by being read by a PC. The computer-readable recording medium includes a magnetic recording medium, an optical recording medium, a carrier wave medium, and others. In addition, the program for preventing children from close-up screen viewing described above may be stored in a computer readable recording medium, and the above described functions may be implemented by being read and executed by a computer.

The present invention has been described above with respect to embodiments thereof. Those skilled in the art should understand that various changes in form and details may be made therein without departing from the spirit and scope of the present invention. Therefore, the embodiments described herein should be considered from an illustrative aspect rather than from a restrictive aspect. The scope of the present invention should be defined not by the detailed description but by the appended claims, and all differences falling within a scope equivalent to the claims should be construed as being included in the present invention.

What is claimed is:

1. An apparatus for preventing children from close-up screen viewing, the apparatus comprising:
a viewing distance determining unit determining whether or not a viewing distance of a user is equal to or smaller than a reference distance; and
a viewing blocking unit performing at least one of blocking output to a screen and switching the screen to silent when the viewing distance is equal to or smaller than the reference distance.

2. The apparatus of claim 1, further comprising a target determining unit determining whether or not the user is a target for preventing from close-up screen viewing, wherein the viewing blocking unit functions when the user is the target for preventing from close-up screen viewing.

3. The apparatus of claim 2, wherein the target determining unit determines that the user is the target to be prevented from close-up screen viewing when a screen touch range of the user is equal to or smaller than a reference range.

4. The apparatus of claim 1, further comprising a volume limiting unit variably setting a maximum volume according to a neighbor noise decibel.

5. The apparatus of claim 1, further comprising a virtual call forwarding unit displaying a virtual call forward screen when a viewing time of the user reaches a predetermined time.

6. The apparatus of claim 1, further comprising a remote control transmitter transmitting to a digital broadcast receiver a command for performing at least one of blocking output to the screen or switching the screen to silent when a distance with the digital broadcast receiver is equal to or smaller than a predetermined distance.

7. A method of preventing children from close-up screen viewing, the method comprising:
determining whether or not a viewing distance of a user is equal to or smaller than a reference distance; and
performing at least one of blocking output to a screen and switching the screen to silent when the viewing distance is equal to or smaller than the reference distance.

8. The method of claim 7, further comprising determining whether or not the user is a target for preventing from close-up screen viewing, wherein the performing of at least one of blocking output to the screen and switching the screen to silent is performed when the user is determined as the target for preventing from close-up screen viewing.

9. The method of claim 7, wherein the user is determined as the target to be prevented from close-up screen viewing when a screen touch range of the user is equal to or smaller than a reference range.

10. The method of claim 7, further comprising variably setting a maximum volume according to a neighbor noise decibel.

11. The method of claim 7, further comprising displaying a virtual call forward screen when a viewing time of the user reaches a predetermined time.

12. The method of claim 7, further comprising transmitting a command for performing at least one of blocking output to the screen or switching the screen to silent when a distance with the digital broadcast receiver is equal to or smaller than a predetermined distance.

13. A computer readable recording medium storing a program for a method of preventing children from close-up screen viewing, wherein the method includes:
determining whether or not a viewing distance of a user is equal to or smaller than a reference distance; and
performing at least one of blocking output to a screen and switching the screen to silent when the viewing distance is equal to or smaller than the reference distance.
